(19) United States
(12) Patent Application Publication
(10) Pub. No.: US 2020/0389514 A1
(43) Pub. Date: Dec. 10, 2020

(54) A SYSTEM AND METHOD FOR MANAGING INFORMATION BETWEEN A SERVER AND A COMPUTERIZED DEVICE

(71) Applicant: MAGIC SOLUTION CREATIVE COMMUNICATION AND COMPUTING LTD., SHAAREY TIKVA (IL)

(72) Inventor: AMIR BARNOY, SHAAREY TIKVA (IL)

(21) Appl. No.: 16/955,145

(22) PCT Filed: Dec. 18, 2018
(86) PCT No.: PCT/IL2018/051370

§ 371 Date: Jun. 18, 2020

Related U.S. Application Data
(60) Provisional application No. 62/599,934, filed on Dec. 18, 2017.

(51) Int. Cl. H04L 29/08; G06F 16/953; G06F 16/957; G06F 16/9035

(52) U.S. Cl. CPC H04L 67/025; G06F 16/953; H04L 67/1004; G06F 16/9035; G06F 16/9577

(57) ABSTRACT

The subject matter discloses a method and computerized product for processing information received at a computerized device and formatting the received information to a time-based and searchable feed. The information comprises communication sessions, either via text, video and audio, as well as media items and information collected via third party resources such as social networks and web pages. The method comprises processing the information from all the sources into a single time-based feed. The user can search the feed according to search queries, such as contact persons and other subjects and the search result, displayed as a time-based feed, includes reviewing the content in the media items and from the third party resources. One user can watch items from feeds of other users.

### FIELD OF THE INVENTION

The present invention generally relates to managing information between a server (such as amazon AWS) and a computerized device.

### BACKGROUND OF THE INVENTION

A personal information management (PIM) is a group of processes people perform in order to acquire, organize, maintain, retrieve and use personal information. PIM deals with information collections and method which can help people arrange their personal relations and the business relation in a simple and easy manner, while most of the documents, pieces of information, calendar events and other personal related items can be stored and organized in a centric fashion. PIM considers not only the methods used to store and organize information, but also is concerned with how people retrieve information from their collections for re-use. One of the challenges PIM applications may have today is how to connect the personal events, the personal information, ad-hoc information, documents and more, into one manageable structure. Furthermore, commonly used mobile telephone devices create multiple data items every hour, which creates another challenge to the PIM application: How to keep track with the data collection and how to extract data, transform it and finally load it into a coherent and manageable data structure. A reliable ETL (Extract, Transform, and Load) if so, has become one of the challenges of our rapidly changing environment, wherein every person holding a computerized device which creates multiple PIM related items on a daily basis.

### SUMMARY OF THE INVENTION

The present invention discloses a method and a product operated on computerized devices for managing information extracted from in communication sessions taking place between a person operating a computerized device and other contacts, as well as information received from third parties. In some cases, the communication session taking place between the person and the contact, or contacts, can be audio conversations, video conversations, text conversations, exchanging recorded audio file, or any combination thereof. The product disclosed in the present invention can also allow the person communicating by a computerized device to capture the digital media data produced during the communication session, and to convert the digital media data to a digital media file. Such a digital media file may be a file encoded in a computer-readable format such as an audio file, a video file, and the like. Managing the information comprises arranging the communication sessions, media file generated during the communication sessions and the data from the third parties according to the time in which they were generated or sent to the computerized device. After arranged according to their time stamp, the information stored in the computerized device may be processed, sorted and analyzed. For example, user operating the computerized device may sort data items that were sent to the computerized device from multiple sources, as all the data items are accessed by a single computerized application. Thus, for example, a user can search for a contact and the search results will provide a timeline including all communication sessions and media items related to the contact. This provides a coherent image of the user's digital relationship with the contact, as we often communicate with others using SMS messages, instant messaging, email messages, meetings, phone and video conversations and images. The term contact may be defined as a contact person or a device communicating with the computerized device, such as a camera, a sensor, an electrical appliance and the like. This way the user can search for the word “report” and the search result a be a timeline including the communication sessions, in text, audio and video, and media files that include the term “report”.

In some cases, the personal information managed by the person operating the computerized device may comprise content items associated with the digital media file. Said content items may be such as, written comments, textual notes, audio files, digital video files, contacts from a contact list, and the like. In some cases, the personal information managed by the person operating the computerized device may comprise events associated with digital media files produced by the communication sessions, wherein such events can be related to a contact or contacts in a personal contact list. Said events are defined herein as scheduling related cases such as electronic reminders, meetings scheduled in an electronic calendar, audio recording of notes or phone discussions, tasks associated with the contacts, and the like.

The computerized devices utilized for the communication sessions can be a mobile telephone device, a personal computer, tablet personal computer, WebTop, a computerized device which can communicate over telecommunications networks, and the like. The computerized devices may be used by a user, also denoted as a person. In some cases, multiple users use the same computerized device using the same account, or different accounts, as desired. In possible embodiments of the present invention, the computerized devices may upload the captured digital media file to a dedicated server, also called a PIM server. The PIM server may be configured to communicate with the computerized devices, receive and store digital media file, update contact lists, add new contacts, manage several of persons connected to the PIM server, and provide management utilities for the persons, in order to manage the personal information in a centric fashion according to the time stamp defined for the items stored in the PIM server and appearing in the timeline provided to the user. The PIM server may also maintain the events and the content items associated with the digital media file.

In some cases, the PIM server may also be configured to manage centric events denoted as PIM server events and share said PIM server events among other persons. For example, a person can create a PIM server event such as a meeting with a contact. Thus, a person utilizing a computerized device may create a meeting event with a contact, or contacts, on a centric calendar configured at the PIM server. The PIM server may be able to synchronize the PIM server events with other persons utilizing the PIM server.

In some cases, the computerized devices configured to connect with the PIM server may operate a product application configured to control the communication and data updating with the PIM server. In some cases, the product application may also comprise a dedicate interface for creating and/or managing content items, such as media files, meetings, communication sessions and the like. The dedicated interface enables the users to associate the content items with contacts in contact list, as a personal information. In some other cases, the persons may also be able to utilize the dedicate interface for associating comments, notes, and information with a digital media file in a specific time stamp. For example, a person can display a digital video file in the dedicate interface of the product application, add new content items such as audio or text notes, change, or edit the digital video file, then associate the edited digital video file with a specific contact, or contacts, and send the digital video file to the PIM server. The text note is associated with a time stamp in the communication session or media file, to enable the user to read the note and find the exact time in the conference or lecture associated with the text note, as notes are better searched compared to video and audio content.

In some cases, the person may also be able to associate the digital media file with a PIM server event and store said media file at the PIM server. For example, a person can associate a digital media file associated with a contact to a PIM server event such as a meeting scheduled with said contact.

The present invention enables docketing user's interactions. The interaction may be with media files, for example audio files or video files, either recorded by the user or stored on his device or another device. The interaction may be in a meeting, lecture taken by the user, a webinar, conversation, chat conversation and the like. The user may add data to the interaction, for example textual comments, audio, a link, a document and the like. The data added by the user, and associated with a specific interaction, is automatically uploaded to the PIM server, thus enabling synchronizing the data between the user's device and the PIM server. The PIM server may communicate with multiple devices associated with different persons, associate the interactions and data added by the user to users authorized to access them according to predefined rules. The server enables reviewing the media item associated with the interaction, for example the conversation or lecture, while reviewing the data added by the user in the relevant time stamp in the interaction.

The user may review the media file itself, representing the interaction, or the media item enriched with the data added by the user in the corresponding time stamp. The user may docket his/her interactions and reconstruct them along with her/his comments as saved on the server. When a single person has multiple devices communicating with the PIM server, the interactions and data loaded by the specific user to the server from at least one of the multiple devices. The loaded data is then accessible to each of the multiple devices associated with the specific user, from the PIM server, regardless to the device from which data was loaded to the server.

The PIM server enables transferring and/or sharing data files between different users communicating with the server. In some cases, the sharing is enabled only between users who participated in the interaction as defined by one of the users, for example a meeting, lecture and the like. Sharing may be done during the interaction, for example during a phone conversation or chat, between all participants or a portion of the participants.

In some exemplary cases, the PIM server enables the user to input commands during the interaction, for example during a meeting, phone conversation or lecture. Such commands may be selected from a predefined list, for example “send task to John”. The PIM server may send information concerning a party of the interaction to the user's device during the interaction. Such information may be customer's financial balance, previous meeting summary, list of tasks associated with the person and the like. In case the scheduling of interactions are updated, the PIM server may respond automatically by sending corresponding messages to the user's contacts with which the user is about to meet.

In some exemplary cases, the present invention also discloses creating or identifying triggers associated with the interactions of the user. Such triggers may be associated with the media files, or in general during the user's interactions. For example, the user may mark time frame, for example seconds 90-120 during a video or a lecture, and assign that time frame to a task or send the time frame as a link or attachment to a contact. The task associated with the time frame may be simple, for example “follow-up”, or send to a date on the user's diary to handle, or may be selected from a list suggested by the server.

The present invention also enables loading content during any kind of interaction, not only an interaction associated with a media file such as a phone conversation, video or chat. For example, the server may load specific text extracted from prior email from a client to the user's calendar, when identifying a meeting with the same client. Extracting the specific text may be performed according to a set of rules and personalized priorities of the user.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 discloses a method for updating information and content associated with a contact or contacts in a computerized device and in a PIM server, according to exemplary embodiments of the present invention;

FIG. 2 discloses a method for creating an event and associate thereof with a contact or contacts defined in a computerized device and in a PIM server, according to exemplary embodiments of the present invention;

FIG. 3A discloses a process of creating a media and associate thereof with a contact on the PIM server, according to exemplary embodiments of the present invention;

FIG. 3B discloses a process of creating a digital media file at the PIM server and associating thereof with multiple optional content items and/or events, according to exemplary embodiments of the present invention;

FIG. 4 discloses a process of changing and editing a digital media file which has already been uploaded previously by a person, according to exemplary embodiments of the present invention;

FIG. 5 discloses a method associating a contact to a PIM server event and to a digital media file associated with the PIM server event, according to exemplary embodiments of the present invention;

FIG. 6 shows a schematic view of a product application operated on a computerized device, wherein the computerized device is connected with a PIM server, according to exemplary embodiments of the present invention;

FIG. 7 Shows a personal interface designed to display and edit digital media files and associate the digital media files with contacts and with PIM server events, according to exemplary embodiments of the present invention; and,

FIG. 8 discloses a configuration of time counting event associated with a contact, according to exemplary embodiments of the present invention;

FIG. 9 discloses a process of creating a media file and associating thereof with multiple optional content items and event during the creation time, according to exemplary embodiments of the present invention;

FIG. 10 shows a schematic view of the media file database connected to media player interfaces, according to exemplary embodiments of the present invention;

FIGS. 11A-11B show feeds of items collected from multiple resources and displayed on a computerized device sorted by time, according to exemplary embodiments of the subject matter.

### DETAILED DESCRIPTION OF THE INVENTION

The present invention discloses a method and a computerized product for managing personal information between a computerized device operated by a person, and a PIM server designed to manage and control said personal information. In some cases, the computerized device may be designed to carry and manage digital communication sessions over telecommunications networks.

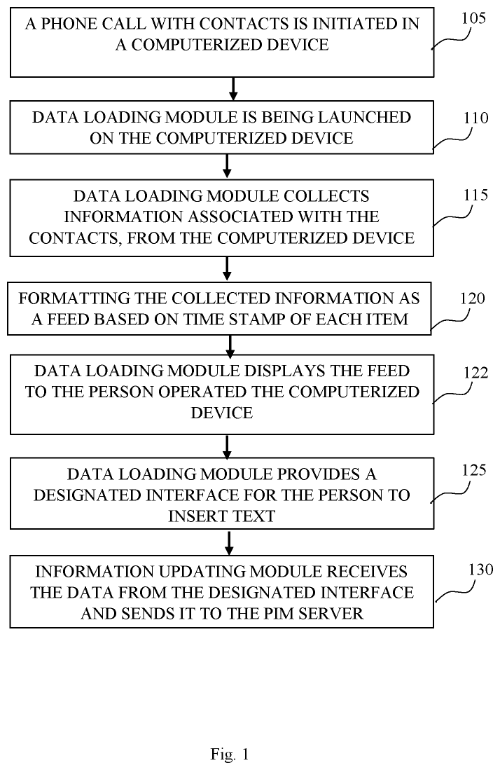

FIG. 1 discloses a method for updating information and content associated with a contact or contacts in a computerized device and in a PIM server, according to exemplary embodiments of the present invention. In step 105 a communication session with a contact or contacts initiates. The communication session may be received by a computerized device which may be connected to a PIM server. In some cases, the communication session can be an audio telephone call, or a video conversation initiated by a person operating the computerized device. In some other cases, the communication session may be an incoming phone call initiated by a calling person which may be listed in the contact list. In some cases, the communication session may be a text conversation managed by exchanging text messages between the person operating the computerized device and another person using another computerized device.

In some cases, wherein the communication session is initiated by the person operating the computerized device, the called person may be chosen from a contact list managed by a third-party application. For example, the third-party software application is configured for sending and receiving text messages among the contacts. The contact list and the contact groups managed by the software application may be used by the person to choose a called person.

In step 110, a data loading module for collecting and demonstrating data associated with the call person may be launched. The data loading module may be a module operated by a product application as explained below. The product application is defined as an application software designed to operate on the computerized device and implement the method disclosed in the present invention. In some cases, the data loading module may be executed before the computerized device initiates the communication session, such that once the discussion starts, the data collection begins. For example, a text conversation takes place between a person operating a mobile telephone device and a call person. For such a conversation, an application for sending and receiving text messages may be used by both sides. Thus, once the text conversation begins, the data loading module for collecting and demonstrating data associated with the call person may be launched. In some cases, the data loading module may also establish a communication with the PIM server.

In step 115, the data loading module collects data and personal information associated with the call person from multiple applications installed on the computerized device. Such multiple applications may include calendar applications, contact list management application, instant messaging applications, databases comprising contacts, email applications, digital media files associated with the contact's name, and the like. the collected data is associated with a time stamp, for example meeting time, time of receipt of media file from the user or creation of media file the user defined as related to the contact, time of receipt of email message or any other type of message received and associated with the contact, and the like. In some cases, the data and personal information collected by the data loading module may comprise notes related to the call person, the last meeting schedule with the contact according to a calendar application, time of the last text exchanging with the contact, and the like. In some cases, the personal information collected by the data loading module may comprise birthday, place of living, favorite music tracks, job title, links to personal pages in social media applications, favorite images and photos, and the like.

In step 120 the information collected by the data loading module is formatted as an endless feed sorted according to the timestamp associated with each item in the feed. In step 122, the endless feed is displayed on the screen of the computerized device, for making it available to the person operating the computerized device to perform actions on the feed as explained below. In some cases, the information may be displayed on a designated display application designed to display digital media files, such as, music, video, audio file, and the like. In step 125, the person operating the computerized device manages the information in the computerized device. Managing the information may include adding, removing, changing or edit the information associated with the contact. For example, the person who operates the computerized device may change the birthday of the contact, change the age, or any other detail associated with the contact using the device's input unit, such as a touch screen, mouse, keyboard and the like.

In step 130, an information updating module operated by the product application is executed and then updates the data existing in the computerized device and the data existing at the PIM server. For example, in case the person operating the mobile telephone device has changed the information of a particular contact, or associated an event such as a meeting in the calendar application with that particular contact. The information updating module may receive the information and update the relevant applications installed in the computerized device and PIM server. The information updating module may be a module operated by the product application.

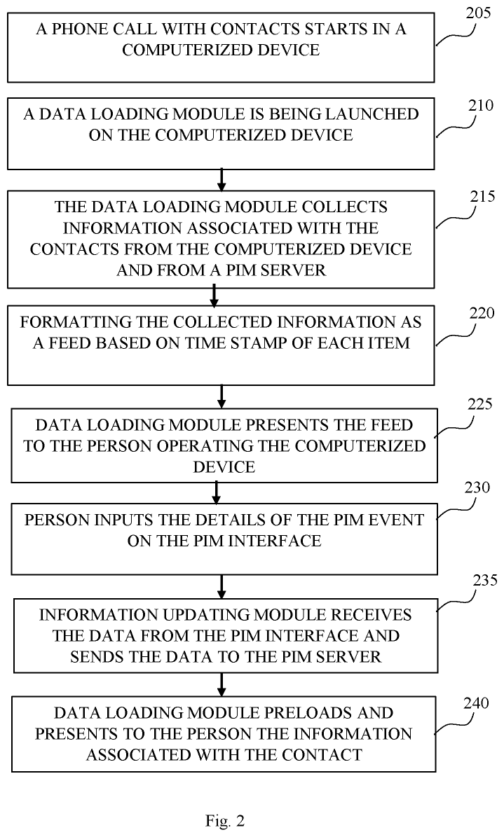

FIG. 2 discloses a method for creating an event and associate the event with a contact or contacts defined in a computerized device and in a PIM server, according to exemplary embodiments of the present invention. In step 205, a communication session with a contact or contacts initiates. The communication session may be initiated by a person operating the computerized device or by another person which may be listed in the contact list.

In step 210, the data loading module operated by the product application may be launched. Thus, once the conversation begins, the data loading module may be operated. In some cases, the data loading module may also establish a communication with a PIM server.

In step 215 the data loading module collect data associated with the call person from the multiple applications installed on the computerized device or installed on a remote server communicating with the computerized device and from the PIM server. The data loading module may collect information from a social network account associated with the user, or with the computerized device, for example via dedicated APIs. Collection of the data may be based on a predefined set of rules. In some exemplary cases, collection of data may be triggered by a predefined trigger, for example the user's gesture, text, sound, command and the like. For example, the computerized device may comprise a camera capturing the user's motions and identifying a motion as a trigger to collect information from the user's instagram's account and associate the collected information with a person the user currently has a communication session with. Such multiple applications may include a calendar application, contact list management application, instant messaging applications, databases comprising contacts, digital media files associated with the contact's name, and the like. In some cases, the data collected by the data loading module may comprise diverse types of data and information items such as notes related to the call person, the last meeting scheduled with the contact according to a calendar application, time of the last text exchanged with the contact, and the like. In some cases, personal information may be collected by the data loading module. Such information may comprise birthday, place of living, favorite music tracks, job title, links to personal pages in social media applications, favorite images and photos, and the like. In some cases, information on PIM event may be also collected by the data loading module. The PIM events may be meetings, updates, tasks, reminders, and the like.

In step 220 the information collected by the data loading module is formatted as an endless feed sorted according to the timestamp associated with each item in the feed. In step 225, the information collected by the data loading module may be displayed on the screen of the mobile computerized device. In some cases, the information may be shown on a designated display application which can also display a digital media files, such as, music, video, audio file, and the like. In step 230 the person operating the computerized device manages events, for example by creating, editing, or changing PIM server events. A PIM server event may be a meeting scheduled on a calendar operated on the PIM server, tasks associated with the call person, notification associated with time tables, tasks associated with the call person and timelines, and the like. The person operating the computerized device inputs the details of the event in a dedicated interface operated by the computerized device, or in some cases in a dedicated interface communicates with the PIM server. For example, the details of the event may be inputted via an interface designed to connect with the PIM server or with other services like Google to load their data (for example Google Calendar) via internet connections. In some cases, once the information is filled in, the person can save the information. In some cases, wherein the call person cannot be found in the contact list on the computerized device, an optional interim interface may manifest on the screen of the computerized device and the person operating the computerized device may add the call person to the contact list, and then continue with the PIM server event creation. In step 235, the person which created the event may complete the update and press on a button. Thus, the data loading module may receive the information, connects with the PIM server and update the PIM server with the added information. In some cases, connecting to the contacts in the contact list residing on the PIM server may require a person ID associated with the person. In such a case, an ID verification may take place before adding a PIM server event associated with a contact.

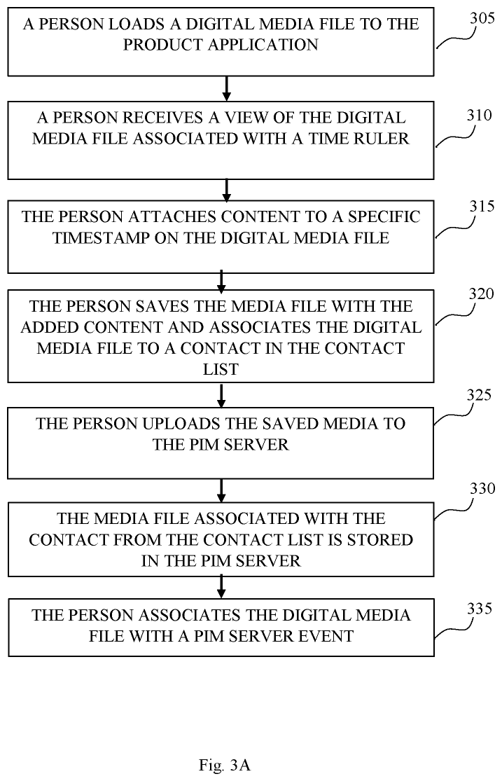

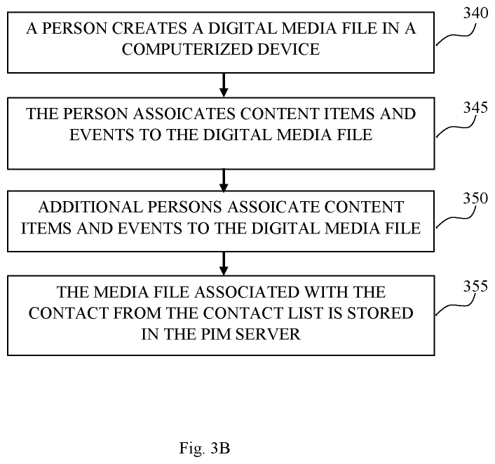

FIG. 3A discloses a process of using a media file and associating thereof with a contact on the PIM server, according to exemplary embodiments of the present invention. The media file may be stored in the user's computerized device, in the PIM server, or in a remote device communicating with the above, for example a web server on which media files are stored, such as YouTube server. The server enables associating the media file having a specific timestamp to a contact or to another event, using the interface of the dedicated application, along with the URL of the media file. In some exemplary embodiment, the present invention also discloses associating content to day-to-day operations, for example working hours or visit in a specific place, and the user or another person interacting with the user may initiate the time frame. For example, the user may initiate the time frame when beginning working day or when beginning a task on a working day. Thus, the media file associated with a specific time stamp relative to the working day, for example 2 hours after beginning of the working day. Such association may enable employees' supervision.

Step 305 describes loading a digital media file to a product application operated on a computerized device. The digital media file may be a digital media file comprising a timely evolving computerized content such as audio file, video file and the like. In some cases, the digital media file may be an audio recorded by the person operating the product application. For example, a person can create a memorandum, or a reminder by recording himself or herself with the mobile telephone device. In some cases, the person may record a telephone conversation and input a command to upload the recording as a digital media file to the PIM server, or to store the recording in the computerized device. In such cases, the person may enable recording capabilities at the product application and the conversation recording may begin. Upon ending the call, the person may be able to edit the audio file, associate it with the call person, shorten the media file, and the like.

In step 310, the person operating the computerized device may open the digital media file with a dedicated interface provided by the product application. The dedicated interface may enable the person to view the digital media file associated with a time ruler. In step 315, the person may be able to set the time ruler in a specific point in time and attach a content item to the specific point in time. In some cases, such a content item may be text notes, a media file, an icon, a digital image file, or any other computerized content which can be operated and executed by a computerized device. For example, a person may set the media file in a specific point in time, and then add a written notification which may show up at the same point in time, in cases the digital media file is displayed.

In some cases, the person may be able to add written notifications, video files, or recorded audio files in real-time, for example while conducting a phone call. For example, a person utilizing the interface of the product application to view a digital media file may have the corresponding interface to record an audio reminder and associate the audio reminder to a specific point in time of the digital media file.

In step 315, the person may utilize the product application to save the digital media file with all the changes and additions, in a memory storage associated with the computerized device. For example, the storage of the computerized device may be designed to store digital contents within the computerize device. In some cases, the digital content may be stored remotely and connected to the computerized device via a communication network. In some embodiments of the present invention, the product application may automatically create a feed including a sequence of notifications, recording, video files, and other content added by the person or received from third parties such as web-based applications. For example, a person can add to a video, or notification or video conference. Thus, the product application may save the digital media file in completeness.

In step 320, the person can associate the saved digital media file with a contact in the contact list. In step 325, the person may upload the saved digital media file associated with a contact from the contact list to the PIM server. In step 330, the media file associated with the contact from the contact list is stored in the PIM server. In some cases, the contact associated with the media file may be represented by an ID. Such ID may be any ID file or ID means which may be utilized by a person having ordinary skills in the art, for identification process taking place between a computerized device and a computerized server.

In step 335, the person may utilize the product application to associate the digital media file with a PIM event. For example, the person may upload to the PIM server a video file integrated with text comments prepared by the person, the text comments are associated with time stamps in the video file, for example 10 minutes and 22 seconds from the beginning of the video file. The person may be able to upload the digital media file and associate said digital media file with a meeting event on the calendar application operated by the PIM server. The person may also be able to associate the digital media file with reminders, with other persons utilizing the server, with an email program, and the like.

FIG. 3B discloses a process of creating a digital media file at the PIM server and associating thereof with multiple content items and/or events, according to exemplary embodiments of the present invention. Step 340 describes creating a digital media file on the computerized device. In some cases, such a media file can be created during the communication session between two persons, as aforementioned. In some cases, an uploading process of the digital media file, from the mobile computerized device to the PIM server may take place during the creation of said digital media file. For example, two persons may have a communication session, wherein one person can be recording the conversation. In some cases, the uploading process of the digital media file to the PIM server may take place at the time the digital media file is being produced by the recording process.

In step 345, the person created the digital media file associates content items to the digital media file. For example, the person may utilize the product application to add a text notification, add an audio recording and associate the content items to the digital media file comprising the recording of the conversation. In some cases, the digital media file may be a digital video file, thus, the person may associate textual notes or comments which may be seen as a part of the digital video file as explained below.

In step 350 additional persons connected to the PIM server may associate additional content items, contacts, events, and the like, to the digital media file. For example, a person connected to the PIM server may add textual comments, or associate an image which may appear in a certain point in time, at the digital media file.

In step 355 the person creating the digital media file completes the file creation and stores the digital media file. In some cases, upon storing the digital media file the person created the file may also associate a contact in a contact list to said digital media file. In some cases, the person that created the digital media file may also associate events to the digital media file after saving the digital media file at the PIM server, as aforementioned.

In some cases, the contact associated with the digital media file may be represented by an ID. Such an ID may be any ID file or ID mean which may be utilized by a person having ordinary skills in the art, for identification process taking place between a computerized device and a computerized server.

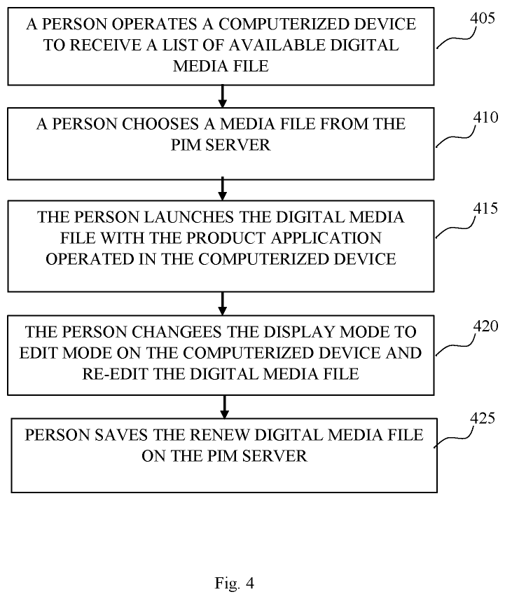

FIG. 4 discloses a process of editing a digital media file which has uploaded by a person, according to exemplary embodiments of the present invention. In step 405, a person operating the computerized device may open the product application and utilize the product application to display an endless feed of the digital media files stored in the PIM server ordered by their time stamp. In some embodiments of the present invention, the digital media files listed by the product application may be associated with contacts when the digital media files are stored at the PIM server. Such association may be done automatically in case the media files are part of the conversation with the contact. In some cases, the person may be able to view the names of the contacts associated with the digital media file. In step 410, the person may chose a digital media file stored at the PIM server using a dedicated interface of the product application.

In step 415, the person launches the digital media file by the product application at the computerized device. In such case, the person may be able to display the digital media file, review the events and additional content items associated with points in time along the digital media file. In some cases, the person may also be able to view the contacts associated with the digital media file. The person may also be able to view the events associated with the digital media file as stored at the PIM server.

In step 420, the person may change the view mode to edit mode and thereby edit content items. The person may reedit the digital media file, add content items to the digital media file, change content items, associate additional contacts or additional PIM server events, remove existing contacts, or existing PIM server events, and the like. In step 425, the person may save the reedited digital media file. In some cases, the person may replace the previous digital media file with the reedited digital media file. For example, the person may launch a file associated with a contact and a PIM server event. The person may remove the PIM server event associated with the file and save the digital media file lacking the event. In such case, the person may upload the digital media file instead of the previous digital media file. In some other cases, the person may save the digital media file under a different name or different reference and newly edited digital media file may be added without replacing the previous digital media file.

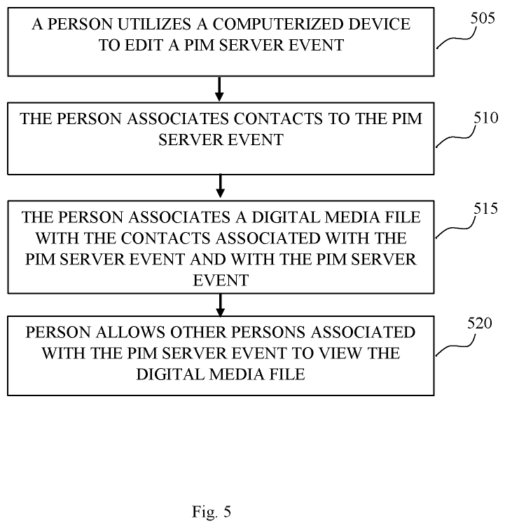

FIG. 5 discloses a method for associating a contact with a PIM server event and to a digital media file associated with the PIM server event, according to exemplary embodiments of the present invention. In step 505, a person operating the computerized device launches the product application and chooses a PIM server event for editing. In step 510, the person may choose a contact from the personal contact list residing at the computerized device and associate the selected contact with the PIM server event. In some cases, the PIM server may also provide a list of contacts registered at the PIM server, and the person may able to choose a contact from the PIM server contact list. For example, in case the PIM server event is a video conference with a customer, the person may be able to associate the name of the customer to the video conference.

In step 515, the person may associate a digital media file with the PIM server event and with a contact. The person can also associate the digital media file with the PIM server event. In some cases, the person associated the contact with the PIM server event may choose to end the editing session and waive the option of associating a digital media file with the PIM server event. In step 520, the person may configure the PIM server event such that, persons having access permissions to the PIM server events may be able to view the digital media file and the contacts associated with said PIM server event. In some embodiments of the present invention, the person may also have the option to set additional permissions to other persons which have access permissions to the PIM server. The access permissions may include editing digital media files associated with a PIM event, editing data fields stored in the PIM server, edit or change a PIM server event, add contacts to a PIM server event, and the like.

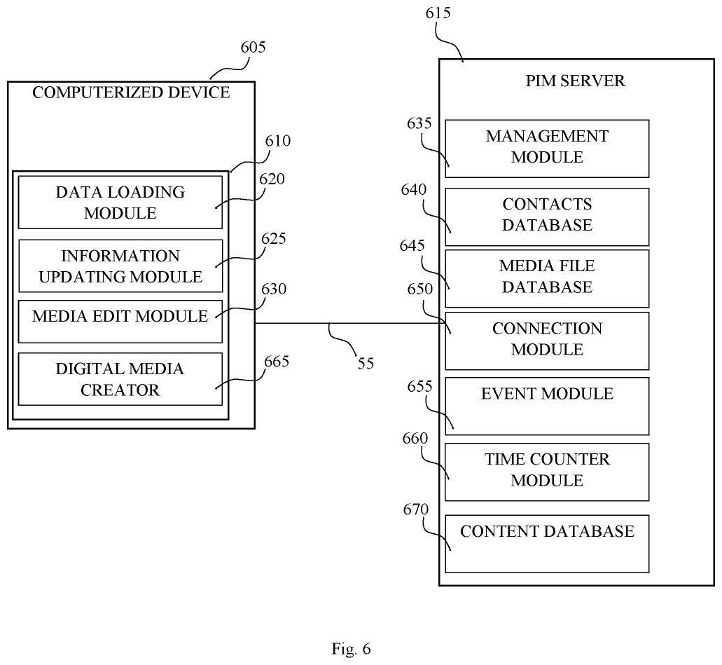

FIG. 6 shows a schematic view of a product application operated on a computerized device, wherein the computerized device is connected with a PIM server, according to exemplary embodiments of the present invention. FIG. 6 shows a computerized device 605 operating a product application 610. The computerized device 605 can communicate with the PIM server 615 via connection 55. In some cases, the connection 55 may be a telecommunications network based connection such as an internet based connection, LAN, WAN, WLAN, and the like. In some cases, the connection 55 may be a Bluetooth connection, wireless connection also known as Wi-Fi connection, Infra-Red connection, and the like.

The product application 610 may comprise a data loading module 620 designed to collect data and personal information associated with the call person from the multiple applications installed on the computerized device 605 or from other devices or storage units communicating with the computerized device 605 or with PIM server 615. The data loading module 620 may also collect information from web pages as defined by the user of the product application 610. Such web pages may be social network web pages or commercial pages in which the user may leave feedback content such as desire to purchase a specific item with the users' contact details. The PIM server 615 may receive the feedback content from the web pages and add the feedback content to the feed of items sorted by the time stamp of each item. The PIM server 615 may also generate a contact person according to the feedback content and add the contact person to the contact list in the computerized device 605. In some cases, some personal details may be also collected by the data loading module 620. Such personal details may comprise birthday, place of living, favorite music tracks, job title, links to personal pages in social media applications, favorite images and photos, and the like.

In some embodiments of the present invention, the data loading module 620 may comprise computerized software interfaces in order to communicate with the operation system of the computerized device 605, or/and with other software applications operated at the computerized device 605 or from other devices, web-based resources or storage units communicating with the computerized device 605 or with PIM server 615. For example, the data loading module 620 may comprise “Android API” in order to communicate and collect data in case the computerized device 605 is operated by Android operating system. the data loading module 620 may comprise multiple interfaces, for example two interfaces for two email applications, for example one interface to GMAIL and another interface for outlook, two interfaces to instant messaging applications, three interfaces for social networks, and 6 interfaces for web pages operated by the user of the computerized device 605. In some cases, the data loading module 620 may be designed to operate and communicate with more than one program interface as a part of the standard operation of the product application 610. The data loading module 620 may be a module controlled and executed by the product application 610.

Product application 610 may also comprise an information updating module 625 designed to receive information and update the relevant data inserted by a person. Such an information may be provided by a person operating the product application. The information updating module 625 may also be configured to communicate the information and the data with the computerized device 605 and with the PIM server 615. The information updating module 625 may be a module managed and executed by the product application 610. For example, in case a person inserted, added or edited a contact to the contact list, added or edited a PIM server event, added or edited information associated with a digital media file, and the like, the product application 610 may utilize the information updating module 625 to update and synchronize the information to the applications operated by the computerized device 605 and to the PIM server 615. In some cases, the information updating module 625 may also comprise program interfaces in order to communicate with the operation system of the computerized device 605, or/and with other software applications operated at the computerized device 605.

Product application 610 may also comprise a digital media creator 665 designed to capture and accumulate the digital media data of the communication session. The digital media creator 665 may also be configured to create the digital media file out of the captured digital media data of the communication session. For example, in case one person and at least one contact of said person have a communication session such as a telephone call, or a video conference call, the person can record the communication session. Thus, the product application may be configured to capture the digital media file in a memory storage at the computerized device. Such a memory storage may be a physical memory storage used to temporarily store the digital data of the recording while it is being accumulated by the recording process. In some cases, the product application 610 may be configured to allow the person recording the digital media file to add content associated with said digital media file as aforementioned.

In some embodiments of the present invention, the digital media creator 665 may also be configured to stream the digital media data to the PIM server 615. The media creator 665 may stream the digital media data to the PIM server 615 directly without storing the digital media data in a digital media file. In such cases, the PIM server 615 may also comprise a buffer configured to temporarily store the digital media data received from the digital media creator 665. In such cases, the management module 635 may also be configured to store the captured digital media data in a digital media file stored in the media file database 645, as elaborated below.

The product application 610 may also comprise a media edit module 630 designed to provide the required interface for persons to add, edit and update information, contacts, data, PIM server events, and digital media files. In some embodiments of the present invention, the media edit module 630 may comprise at least one person interface for editing and managing the content provided and created by the product application 610. In some cases, the media edit module 630 may comprise a module configured to record audio memorandums, a text editor designed to add notes and texts, a video viewer with time scale for associating information and data with digital media files, and the like.

The media edit module 630 may also have some programmed interfaces to communicate with the information updating module 625 and with the data loading module 620. For example, the media edit module 630 may communicate with the loading module 620 to receive content and information collected by the loading module 620, and may also communicate with the information updating module 625 to update further information edited or created by the person.

In some cases, the media edit module 630 may also have programmed interfaces for communicating with the PIM server in order to update the PIM server with newly created content. In such cases, the media edit module 630 may communicate with the connection module 650 in order to update the PIM server and synchronize the information created by the person. For example, in case the person creates a PIM server event, the person may utilize the media edit module 630 to view the information provided by the PIM server and to update the PIM server with new created content.

In some embodiments of the present invention, the mobile computerized device 605 may not be characterized with telephone capabilities. In such cases, the computerized device 605 may be able to contact the call person via video conversation, text exchanging application, and other communication means which may not require telephone capabilities. For example, a person may contact with the call person via an instant messaging application installed in computerized device. In such cases, the product application 610 operated in the computerized device may also be able to connect with the PIM server 615.

In some cases, the PIM server 615 may comprise a digital media file database 645 designed to store the digital media file provided by the person communicating with the PIM server 615. The digital media file database 645 may be configured to communicate with the management module 635, receive digital media files according to the business logics managed by the management module 635. The management module 635 may be able to manage the digital files, associate the digital files to PIM server event and manage the permissions of the persons. For example, the permissions to access digital media files, to change events in the event module 655, and the like. The event module 655 may also be managed by the management module 635 and provide an interface to the events scheduled by the product application 610. Such events may be meetings, reminders, video conferences, and the like. The PIM server 615 may also comprise contact database 640 for listing the contacts held by the PIM server 615.

The PIM server 615 may also comprise a time counter module 660 designed to set time counter associated with a contact. The time counter module 660 can operate a time counter which counts the engagement time with a contact list. Such an engagement time may be a conversation with a contact such as, telephone call, video conference, text message exchanges, and the like. In some cases, the product application 610 may have the corresponding interface for operating the time counter module 660. For example, a person operating the computerized device 605 may set the counter on, to start counting a conversation time with a specific contact. The person may receive an option to start with the counting, the person may turn the start time counting on, and the time counter module 660 may start. In some cases, the time counting for a specific contact may set to be automatic. Thus, the time counter module 660 may count the engagement time automatically for this specific contact.

The PIM server 615 may also comprise a content database 670 designed to comprise the content items associated with the digital media file stored in media file database 640. Thus, in some cases, person which are connected to the PIM server 615 may add content items to specific digital media files stored in the media file database 640. In some cases, diverse persons can add diverse content items and associate the content items with digital media files. In some cases, the digital media file ID associated with the digital media file, may be used to associate content items, events, PIM server events, contacts, or/and PIM server contact to a digital media file. For example, a person can utilize a personal interface, as elaborated below, to open a specific digital media file stored at the media file database 640. In some cases, the digital media file ID may be utilized to identify said digital media file. Then, the person may review, add, change and edit content items, contacts, events, PIM server events, or/and PIM contacts, associated with said digital media file.

In some embodiments of the present invention, the digital media files stored in the media file database 640 may be displayed by a standard digital media player. In such cases, the content items, contacts, events, PIM server events, or/and PIM contacts, associated with said digital media file may not be displayed by the standard digital media player. Such standard digital media players may be any commercial product designed to display standard media files.

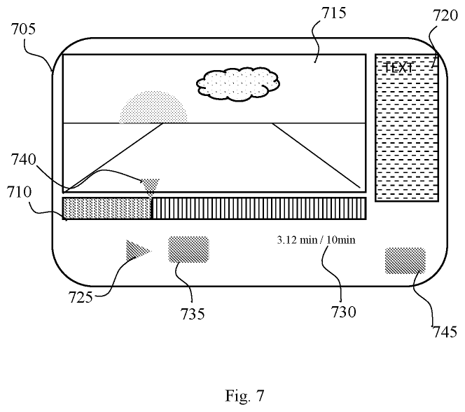

FIG. 7 shows a personal media interface designed to display and edit digital media files and associate the digital media files with contacts and with PIM server events, according to exemplary embodiments of the present invention. FIG. 7 shows a digital media file interface 705 designed to display a digital media file and provide an editing interface for the displayed digital media file. The digital media file interface 705 comprises a display module 715 designed to provide the required display means for editing and viewing digital media files. The digital media file interface 705 also comprises, a time pointer 740 which provides the specific point in time which the digital media file is situated. The time pointer 740 can point at the time scale 710 which provides the elapsed time of the digital media file currently playing. The digital media file interface 705 also comprises a play button 725 configured to play the digital media file, and a stop button 735 configured to stop playing the digital media file played at the digital media file interface 705. The digital media file interface 705 may also comprise a text editor 720 designed to receive text from the person and associate the received text with a specific point in time pointed by the time pointer 740. The text editor 720 may also have an editing mode and a viewer mode for the text associated with the digital media file. Thus, in cases wherein the digital media file interface 705 is utilized as a viewer, the text editor 720 may present the text comments added by the person who edited the digital media file. The digital media file interface 705 may also comprise a time label 730 to show the time progress of the digital media file and a button 745 to save and upload the edited digital media file once the editing work has been completed.

In some cases, the digital media file interface 705 may also comprise additional buttons and controls in order to launch person contact list, choose a contact, add audio file and the like. The digital media file interface 705 may provide the suitable interface to attach any type of data to the specific timestamp in the digital media file. In some cases, the digital media file interface 705 may also comprise an option to record a telephone conversation, or record the environment of the device. In such cases, the digital media file interface 705 may have the suitable controls and buttons to start, stop, edit, and upload the digital media file produced by the telephone conversation recording.

The digital media file interface 705 may also be designed to create a content sequence, for digital media file. In some cases, the media file interface 705 may produce a digital content file comprising the added content items associated with the digital media file, the contact, the events, and the PIM server event. For example, the digital media file interface 705 may create a digital file comprising the textual notifications, the links of the media files, and the like, which were added by the person, and associated with the digital media file. Thus, the digital media file may remain pristine. The digital media file interface 705 may be able to display the pristine digital media file and associate the corresponding content residing in the digital content file. Thus, during display time the digital media file and digital content file may be synchronized, such that the digital media file interface 705 may be able to display the digital media file with the content items as configured.

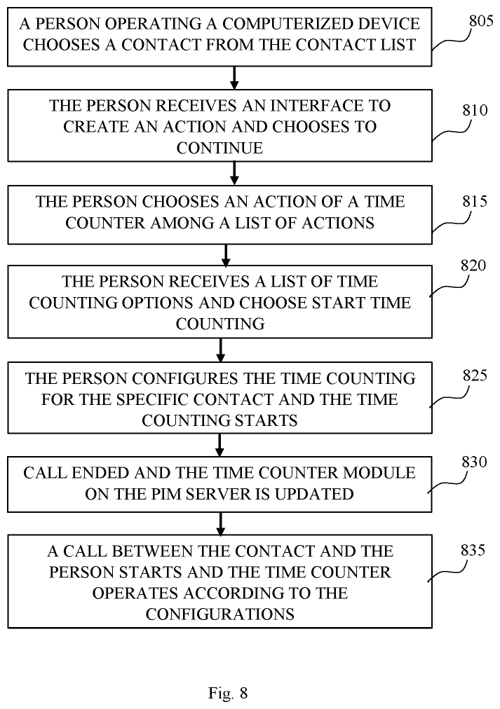

FIG. 8 discloses a process for configuring a time counting event associated with a contact, according to exemplary embodiments of the present invention. In step 805, a person operating a computerized device chooses one or more contacts from a contact list. Such one or more contacts may be in the personal contact list stored in the computerized device, a contact name in a contact list in a computer, a contact in a contact list resides in the PIM server, and the like. In some cases, the action of choosing a contact may occur during a conversation with the contact. In some other cases said action may not be during a conversation with the contact. In step 810 the person may receive an interface to choose an action. The action manifested to the person may be such as, set a time counter, schedule a meeting with the contact, open a task with the contact, set a reminder, and the like.

In step 815 the person may choose the action of a time counter among the action list. In step 820, the person may be provided with a list of counting options. The counting options may be an automatic counting for this specific contact, counting time in case of a specific engagement (E.G., time counting only in case of telephone conversation), counting time in case of engagements with other persons, and the like. In step 825, the person may choose the specific configuration of the time counting, save the configuration and the time counting may start, according to the configuration. In step 830, the call with the contact may end and the value of the counted time may be sent to the PIM server. In some cases, the configuration of the time counter may be sent to the PIM server before the call with the contact ends.

In step 835, another call with the contact may start and the time counter may start to operate according to the configuration. For example, the time counter may be configured to count time with all persons operating computerized devices and connected with the PIM server. In that case, the time counter may count the time wherein calls with other persons take place. Another example can be a time counter configured to count time in case an audio phone call takes place, and to not count the time in case a video conference takes place.

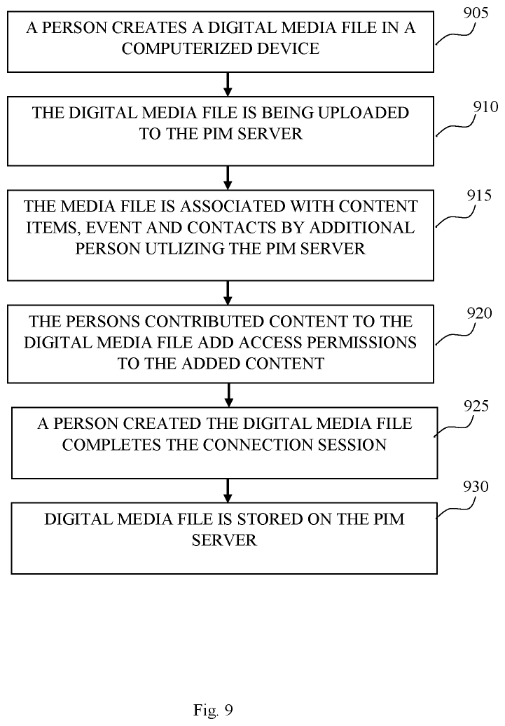

FIG. 9 discloses a process of creating a media file and associating thereof with multiple optional content items and event during the creation time, according to exemplary embodiments of the present invention. Step 905 describes a process of creating a digital media file on a mobile computerized device. In some cases, such a media file can be created on the physical memory of the computerized device, during a communication session between two persons, as aforementioned. In step 910, the person creating the digital media file can start uploading the digital media. In some cases, the digital media data may be up streamed to the PIM server and the digital media file may be created on the PIM server.

In step 915, additional persons which are connected to the PIM server can associate additional content items, and or events, to the digital media file being created on the PIM server. In some cases, such persons may be persons which are authorized to add, edit and change content items and media files on the PIM server. The persons which are connected to the PIM server may also able to associate PIM server event, contacts from contact list, and the like, to the digital media file.

In step 920, the person connected to the PIM server can add user permissions to the newly added content items and event. For example, a person can allow to some other persons to view content items or event associated to the digital media file. In step 925 the person which created the digital media file completes the connection session. In some cases, said person may associate additional content items, event, or contact to said digital media file. In some cases, the person may choose to view the digital media file and thereby to review the content items, the events, the PIM server events and the contacts associated with the digital media file.

In step 930, the digital media file is stored in the PIM server. In such a case, persons which are connected to the PIM server may be able to consume the digital media file, and utilize it as aforementioned. In some cases, the PIM server may update the computerized device operated by the person created the digital media file with the digital media file stored at the PIM server. In some cases, the content items, the events and the contacts associated with the digital media file may also be down streamed and updated at the computerized device. In some other cases, multiple computerized devices may be updated with the digital media file and the associated content. For example, a person digital media file is stored in the PIM server as aforementioned. Then, the PIM server may connect with other computerized devices authorized to receive content from the PIM server and send the digital media file to said computerized device, such that the digital media file, the content items, the events and the contact associated with the digital media file may also be sent and updated at the authorized computerized devices.

In some embodiment of the present invention the PIM server may comprise a mechanism to control the computerized device authorization. In such cases, a person connected to the PIM server may configure permissions for persons defined at the PIM server. For example, a person can configure some contact items associated with specific digital media file may be seen only by an authorized person list. The person may provide edit rights, change rights and the like, to some persons defined in the PIM server.

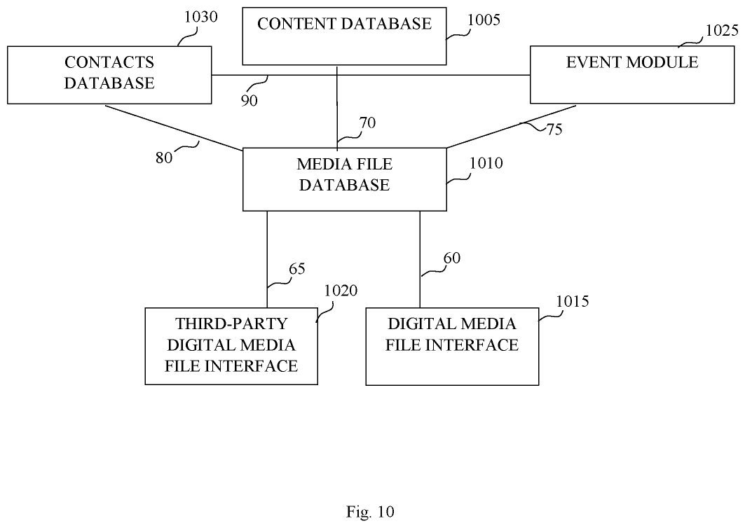

FIG. 10 shows a schematic view of the media file database connected to media player interfaces, according to exemplary embodiments of the present invention. FIG. 10 shows a media file database 1010 which may comprise the digital media files stored in the PIM server. The media file database 1010 can be connected to the content database 1005, and be configured to maintain links between the digital media files and the corresponding content items stored in the content database 1005. In such cases, the media file database 1010 may communicate with the content database 1005 via connection 70 to receive the required connection items. For example, in case a person reviewing a digital media file stored in the media file database 1010. The media file database 1010 may provide the required digital media file merged with the content items associated with the digital media file by communicating via connection 70 with the content database 1005.

The media file database 1010 can also be configured to communicate with the event module 1025 via connection 75 and with the contact database 1030 via connection 80 and communicate in similar fashion as communicating via connection 70 with the content database 1005. In some cases, the content database 1030 may be provided in a separate computerized server. Thus, the connection 80 may be an internet connection or any other communications network based connection such as LAN, WAN, and the like. In some other cases, the event module 1025 may also be provided in a separate computerized server. Thus, the connections 75 may be an internet connection or any other communications network based connection such as LAN, WAN, and the like. The media file database 1010 can also be configured to link between the digital media files and the corresponding PIM events stored in the event module 1025, and with the corresponding contacts defined and stored in the contact database 1030.

In some cases, an event can be associated with a contact stored and defined in the contact database 1030 without associating any digital media file to said contact or event. Thus, the event module 1025 may be configured to utilize connection 90 to receive identifications of the contacts associated with the event. Such an identification may be contact name, contact's telephone number, a user name, a digital ID, and the like. For example, a person can connect to the PIM server, create a new event such as a meeting with a contact at the event module 1025, and then associate the newly created event with one or more contacts defined in contact database 1030.

In some cases, a person can associate a new digital media file with an existing event. For example, a person created an audio file comprising a recording of a telephone conversation. The person can upload the digital media file to be stored in the media file database 1010, and then, associate the digital media file with as event existed in the event module 1025, and/or with contacts defined in the contact database 1030.

The digital media files stored in the media file database 1010 can be consumed by media players designed to display or to play such digit media content. Thus, in some cases, a person may connect to the PIM server in order to play a digital media file stored in the media file database 1010. The person may utilize the digital media file interface 1015 designed to display and edit digital media files and associate the digital media files with contacts and with PIM server events. The digital media file interface 1015 may be configured to display digital media files stored in the media file database 1010 and the corresponding content items, events and contacts associated with the digital media files. In some cases, the media file interface 1015 may also be utilized to edit, change, and configure the digital media file. The media file interface 1015 may also be utilized as an interface for uploading digital media files, download digital media files, and the like.

In some cases, a person may connect to the PIM server in order to play a digital media file stored in the media file database 1010 by utilizing the third-party digital media file interface 1020 which may be any digital media player complying with the industrial standard for digital media. In such cases, the person utilizing the third-party digital media file interface 1020 may not receive the content items, the contact and the events (or PIM events), associated with the digital media files. For example, a person may utilize a standard third-party digital media player for displaying a digital video recording of a video conference, stored in the media database 1010. The person may be able to display the digital video recording but without the additional contact, events, or content items which can be displayed by the media file interface 1015.

In some cases, the media file database 1010 may be configured to identify the digital media player being connected and provide the content accordingly. For example, in case a person connects to the media file database 1010 by the media file interface 1015, the media file database 1010 may be configured to identify the media file interface 1015 and provide the connect items, the events, and the contact associated with the digital media file. In some cases, wherein the media file interface 1015 cannot be recognized by the media file database 1010, the media file database 1010 may display the pristine digital media file without the connect items, the events, and the contact associated with said digital media file.

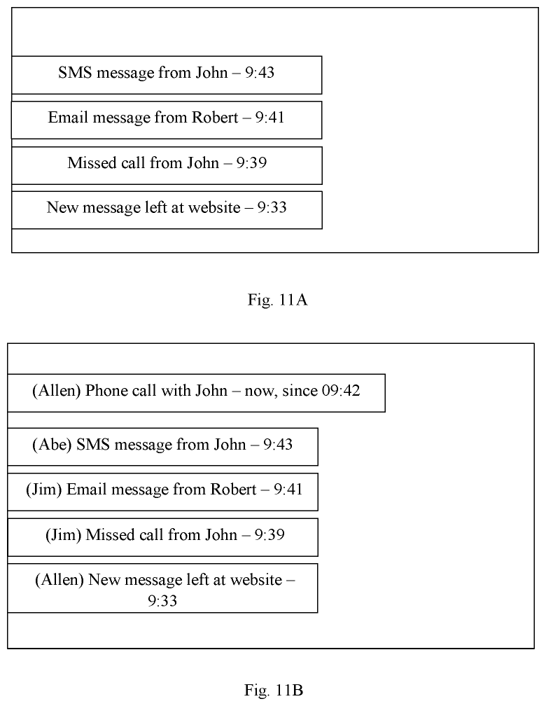

FIG. 11A shows a feed of items collected from multiple resources and displayed on a computerized device sorted by time, according to exemplary embodiments of the subject matter. The feed comprises items such as communication sessions, received media files, notifications from third party resources and the like. The communication sessions may include correspondence of textual messages, such as email messages, SMS, instant messaging applications, as well as audio and video media, such as phone calls, VOIP calls, video chats and the like. The person using the computerized device may input rules and/or settings used to determine which collected information is displayed as part of the feed. FIG. 11B shows a feed of items collected from multiple devices communicating with the computerized device and displayed therein. The feed of items is sorted by time. An identifier of the computerized device associated with each item in the feed may be displayed along with the data item in the feed.

In some exemplary cases, the methods of the subject matter also comprise aggregating the feed of items from multiple computerized devices into a single aggregated feed displayed on the computerized device. The multiple computerized devices may be selected by the user of the computerized device, or according to a predefined rules, for example aggregate all feeds from devices located within 3 kilometers from another device. The aggregated feed can also be searched and the processed feed will be displayed in the computerized device or sent to another device. The search may be based on a search query inputted by the user. In some other cases, the search may be generated automatically, for example in response to a predefined event or trigger, such as a phone call from a specific contact person, or identifying a specific expression in an email, text message or audio conversation received at the computerized device. An example of the aggregate feed may be all workers working on a single client, all family members and the like. The server connected to the multiple computerized devices may enable or disable the aggregate feed based on permissions stored therein. In some cases, the aggregated feed can include items from two computerized devices having the same hierarchy level, for example business partners.

In some exemplary cases, the methods of the subject matter also comprise automatic generation of reports based on the items in the feed of items. The reports may be based on the aggregate feed disclosed above. The reports may be used to evaluate quality of service, work quality, connection and other emotions between persons and the like. The report may be based on one or more contacts communicating with the person using the computerized device, or multiple computerized devices, when generating a report based on an aggregate feed. The one or more persons may be associated with a single process, client or product worked on by the person using the computerized device. Generation of the report may comprise converting the communication sessions and the media items included in the feed into time duration. The report may include a total time spent on the process/client, time spent by each employee, contact person at the client side that consumed most of the employees' time and the like.

The media file in a feed of a computerized device may be shared by multiple computerized devices communicating with the server. The media item may be defined as collaborative, thus additional layers concerning the media file at the multiple computerized devices can be aggregated by the server and downloaded to at least one of the multiple computerized devices. This way, multiple group members can view their colleagues' notes concerning a video they were required to watch while preparing for a meeting.

In some cases, the method of the subject matter comprises associating a media file transferred from one device to another during a communication session between the devices to the contact with which we had the communication session while sending the media file. For example, two persons have a phone call. During the phone call, one user sends an image to another user. The image will be stored at the server with the friend's name and time stamp of sending the image to the friend's device and account.

In some cases, the method of the subject matter comprises processing messages received from a messages receiving service. Such service may be used to collect messages in case a person received a phone call and cannot or is not interested in taking the phone call. The caller is transferred to a human response who collects the message and sends the message to the user's device. The product analyzes the message received from the server and extracts significant information such as name of caller, information left at the web site and the like. In some cases, the messages receiving service is based on a distributed mechanism, in which the messages receiving service workers are located in distinct places, and no device is associated with a central server. The multiple distinct devices enable sending a periodic report of the communication sessions involved with each worker and each client.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method for processing information in a computerized device, the method comprising:
collecting information from communication sessions performed in the computerized device, said communication sessions comprises at least one of audio and textual conversations;
collecting information from third party resources accessible to the computerized device;
formatting the information from the communication sessions and the information from the third-party resources into a feed of items sorted by a timestamp associated with each item;
displaying the feed of items on a display unit of the computerized device.

2. The method according to claim 1, wherein the third party resources automatically send information to the computerized device according to preferences inputted by the computerized device.

3. The method according to claim 1, wherein the third party resources comprise social networks, wherein the social networks send notifications to the computerized device, wherein the feed comprises communication sessions and notifications from the social networks sorted by the timestamp associated with each notification and communication session.

4. The method according to claim 1, wherein the third party resources comprise a web page in which users of the web page can input feedback content, wherein the web page send the feedback content to the computerized device, wherein the feed comprises communication sessions and the feedback content sorted by the timestamp associated with each feedback content and communication session.

5. The method according to claim 4, wherein the web page comprises a field for leaving personal details, wherein the server processes the information inputted by the user of the web page and generating a contact according to the information inputted by the user of the web page, downloading said contact to the contact list of the computerized device.

6. The method according to claim 1, further comprises receiving user's text during a communication session of the communication sessions and displaying the user's text in the feed sorted by the timestamp of receipt of the text.

7. The method according to claim 6, further comprises automatically linking the user's text to a specific time stamp in the communication session according to the time the user inputted the text during the communication session.

8. The method according to claim 1, further comprises:
analyzing the audio conversations,
extracting text from the audio and video conversations;
using the extracted text to determine whether or not to add the analyzed audio and video conversations to the feed of selected items.

9. The method according to claim 1, further comprises collecting a physical trigger using a device connected to the computerized device, wherein processing the feed based on the trigger and a predefined set of rules.

10. The method according to claim 1, wherein the third party resources comprise web-based applications.

11. The method according to claim 1, wherein the third party resources comprise additional computerized devices associated to the computerized device by the server, wherein the method further comprises collecting information from the feed of the additional computerized devices into an aggregated feed comprising aggregated items from the additional computerized devices, said aggregated items are sorted by a timestamp associated with each item of the aggregated items.

12. The method according to claim 11, further comprises filtering the aggregated feed based on a predefined criteria.

13. The method according to claim 12, wherein the predefined criteria is a search query entered by the user of the computerized device.

14. The method according to claim 12, wherein the predefined criteria is generated automatically in response to a predefined event received at the computerized device.

15. The method according to claim 1, further comprises generating reports based on the feed of time-stamp events and a predefined set of rules.

16. The method according to claim 15, wherein the report comprises number of communication sessions associated with one or more contacts and additional content received from the one or more contacts and converting the data items associated with the one or more contacts into time spent in communication with the one or more contacts.

17. The method according to claim 12, wherein the one or more contacts are associated with a client of the person using the computerized device, wherein the report accumulates the time spent on the client by the person using the computerized device.

18. The method according to claim 1, wherein displaying the feed of items on a display unit of the computerized device in response to a predefined event.

19. The method according to claim 1, further comprises receiving a search command from a user of the computerized device to search the content in the feed of items;
processing the items in the feed of items in a server communicating with the computerized device according to the search command, said processing comprises searching the audio and textual conversations;
displaying selected items from the feed of items according to the search command and according to the sorted by the timestamp associated with each item of the selected items.

20. The method according to claim 19, wherein the search command is based on a contact in a contact list of the computerized device, wherein the selected items comprise communication sessions with the contact in multiple applications operating on the computerized device and media files associated with the contact, all sorted by the timestamp of each item.
